(19) United States
(12) Patent Application Publication
(10) Pub. No.: US 2007/0279399 A1
(43) Pub. Date: Dec. 6, 2007

(54) Method and apparatus for obtaining navigation information from a ball mounted in a stylus

(75) Inventors: Ken A. Nishimura, Fremont, CA (US); Jonah A. Harley, Mountainview, CA (US); Ian Hardcastle, Sunnyvale, CA (US)

Correspondence Address: Kathy Manke;Avago Technologies Limited, 4380 Ziegler Road, Fort Collins, CO, 80525, US

(73) Assignee: Avago Technologies ECBU IP (Singapore) Pte. Ltd., Singapore (SG)

(21) Appl. No.: 11/444,015

(22) Filed: May 31, 2006

(51) Int. Cl. G06F 3/033

(52) U.S. Cl. 345/179

(57) ABSTRACT

An apparatus for generating navigation information indicative of translational movement of a stylus including a ball rotatably mounted at an end of the stylus, a sensor system and a processor. The ball has an orientation-indicating property and the sensor system is arranged to sense the orientation-indicating property of the ball. The processor is coupled to the sensor system. In response to successive sensings of the orientation-indicating property, the processor is operable to determine changes in the orientation of the ball and to derive the navigation information from the orientation changes.

### BACKGROUND

Tracking the movement of input devices is well known in the industry. The computer peripheral mouse is a well known example of a device that performs such tracking. Mice are capable of precisely tracking movement. However, it is more difficult for a user to precisely move a mouse than it is for the user to precisely move a stylus.

In some situations it is desirable to input a written page or a drawing into a computer as the words or figures are being written or drawn. It is necessary to track the tip of a writing implement and transmit the data to the computer. In other situations it is desirable to input a written page or a drawing real-time into a memory for storage and later downloading of the data to a computer.

Currently, written or drawn pages are input to a memory or storage medium by scanning the sheet of paper that has the writing or drawing with a scanning device and then downloading the scanned image to the desired memory or storage unit. This process takes time and requires scanning equipment. Scanning equipment is available but, typically, scanning equipment is not portable. Stylus-like input devices exist but they require use with paper that is printed with spaced fiducial marks. Such paper is expensive.

It is desirable to control input to a computer or a processor with a writing implement, such as a pen. It is further desirable to input images, such as drawings or script, drawn or written on a piece of paper, into a computer, such as a laptop, while the images are being drawn or written.

### SUMMARY

A first aspect of the invention provides an apparatus for generating navigation information indicative of translational movement of a stylus. The apparatus includes a ball rotatably mounted at one end of the stylus, a sensor system and a processor. The ball has an orientation-indicating property and the sensor system is arranged to sense the orientation-indicating property of the ball. The processor is coupled to the sensor system. In response to successive sensings of the orientation-indicating property, the processor is operable to determine changes in the orientation of the ball and to derive the navigation information from the orientation changes.

A second aspect of the invention provides a method for obtaining navigation information representing translational movement of a stylus relative to a surface. The method includes providing a ball rotatably mounted at one end of the stylus in a manner that allows the ball to contact the surface. The ball has an orientation-indicating property. The method also includes repetitively sensing the orientation-indicating property of the ball and, in response to the sensing of the orientation-indicating property, determining rotation data representing changes in the orientation of the ball caused by the movement. The method further includes deriving the navigation information from the rotation data.

A third aspect of the invention provides a storage medium in which is stored a program operable to instruct a processor to perform operations that generate navigation information representing translational movement of a stylus relative to a surface. The operations include receiving sensing data indicative of a sensed orientation-indicating property of a ball rotatably mounted in a stylus tip at one end of a stylus. In response to the sensing data, the operations include determining rotation data representing changes in orientation of the ball due to translational movement of the stylus tip relative to a surface and deriving navigation information from the rotation data. The navigation information represents the translational movement of the stylus tip.

### DRAWINGS

FIG. 1 is a diagram showing one embodiment of an apparatus for generating navigation information.

FIG. 2 is a diagram showing another embodiment of an apparatus for generating navigation information.

FIG. 3 is a diagram showing one embodiment of a ball and a sensor system.

FIG. 4 is a diagram showing another embodiment of a ball and a sensor system.

FIG. 5 is a diagram showing yet another embodiment of a ball and a sensor system.

FIG. 6 is a flowchart of an embodiment of a method to obtain navigation information from a ball.

FIG. 7 is a diagram showing a system that displays an object positioned in response to the navigation information generated by the processor.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. It is to be understood that other embodiments may be utilized and that logical, mechanical and electrical changes may be made without departing from the scope of the present invention. The following detailed description is, therefore, not to be taken in a limiting sense.

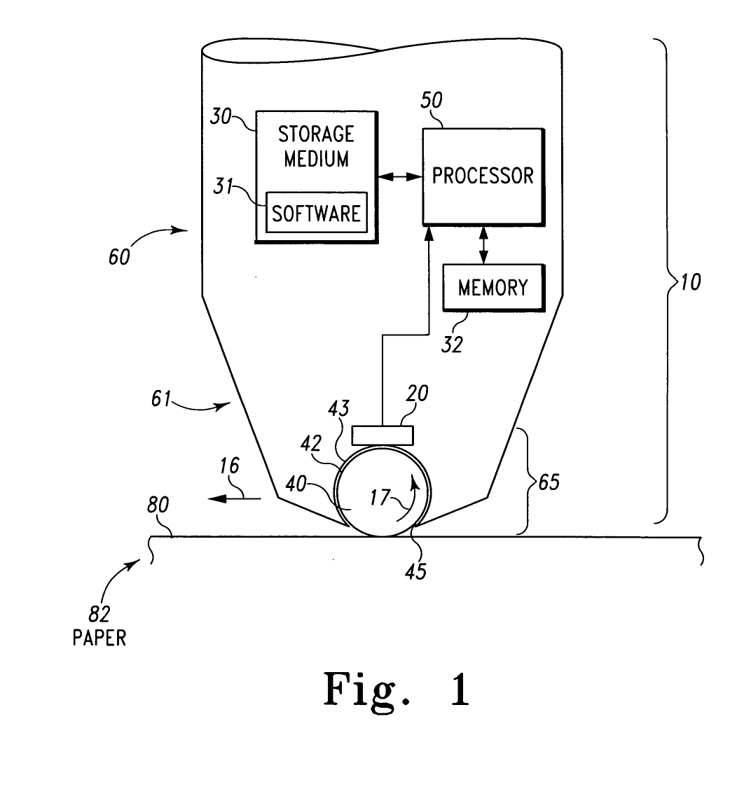

FIG. 1 is a diagram showing one embodiment of an apparatus 10 for generating navigation information. The apparatus 10 includes a sensor system 20, a processor 50, software 31 stored in a storage medium 30, a memory 32, a stylus 60 having a stylus tip 65 at an end of the stylus 60 and a ball 40 held within the stylus tip 65. The stylus tip 65 is disposed circumferentially around a portion of the ball 40 so that the ball 40 is rotatably mounted at the end 61 of the stylus 60. The ball 40 is located in a cavity defined in the stylus tip 65 and represented by the numeral 45. The surface 42 of the ball 40 is in contact with a portion of a surface 43 of the cavity 45. In this configuration, the ball 40 is able to rotate within the cavity 45 of the stylus tip 65.

The ball 40 has an orientation-indicating property that permits the sensor system 20 to sense successive orientations of the ball 40 as the ball 40 rotates in proportion to translational movement of the stylus tip 65 relative to a surface 80 contacted by the ball 40. The sensor system 20 is at least partially disposed in the stylus tip 65 and is arranged to sense the orientation-indicating property of the ball 40. In one implementation of this embodiment, the orientation-indicating property is a visible mark on the surface 42 of the ball 40. The visible mark is optically detected. In another implementation of this embodiment, the orientation-indicating property is an intrinsic quality of the ball 40, such as a magnetism of the ball 40.

The processor 50 is coupled to the sensor system 20, the storage medium 30 and the memory 32. The memory 32 includes any suitable memory now known or later developed such as, for example, random access memory (RAM), read only memory (ROM), and/or registers within the processor 50. The storage medium 30 includes one or more storage devices suitable for embodying computer program instructions and data. The software 31 executed by the processor 50 includes program instructions that are stored or otherwise embodied on the storage medium 30 from which at least a portion of such program instructions are read for execution by the processor 50.

The processor 50 is operable to determine changes in the orientation of the ball 40 in response to successive sensings of the orientation-indicating property by sensor system 20. The processor 50 is additionally operable to derive the navigation information from the orientation changes.

The change of orientation of the ball 40 is proportional to the translational movement of the stylus tip 65 relative to the surface 80 of paper 82 contacted by the ball 40. The surface 80 is referred to here as “writing surface 80” to distinguish it from the surface 42 of the ball 40. In the example shown in FIG. 1, the stylus tip 65 does not transfer ink as a visual indication of the locus of contact between ball 40 and the writing surface 80. The paper 82 is any material that includes a surface 80 that provides sufficient friction to rotate the ball 40 within the cavity 45.

Vector 16 generally indicates the direction of translational movement of the stylus tip 65 and the curved arrow 17 generally indicates the direction in which the orientation of the ball 40 changes within the cavity 45 of the stylus tip 65 in response to the translational movement represented by vector 16.

During the translational movement of the stylus tip 65 relative to the writing surface 80, the orientation of the ball 40 is repetitively sensed by the sensor system 20. The processor 50 executes software 31 that determines changes in the orientation of the ball 40, determines the magnitude and direction of the changes in the orientation of the ball 40 in response to successive sensings and derives navigation information from the orientation changes.

In one implementation, the processor 50 includes a microprocessor or microcontroller. The storage medium 30 includes all forms of non-volatile memory, including by way of example semiconductor memory devices, such as EPROM, EEPROM, and flash memory devices. In one implementation of this embodiment, at least a portion of the software 31 is stored in memory 32 during execution. In another implementation of this embodiment, the memory 32 is a volatile memory. Moreover, although the processor 50 and memory 32 are shown as separate elements in FIG. 1, in one implementation, the processor 50 and memory 32 are implemented in a single device (for example, a single integrated-circuit device). In one implementation, the processor 50 includes processor support chips and/or system support chips such as ASICs.

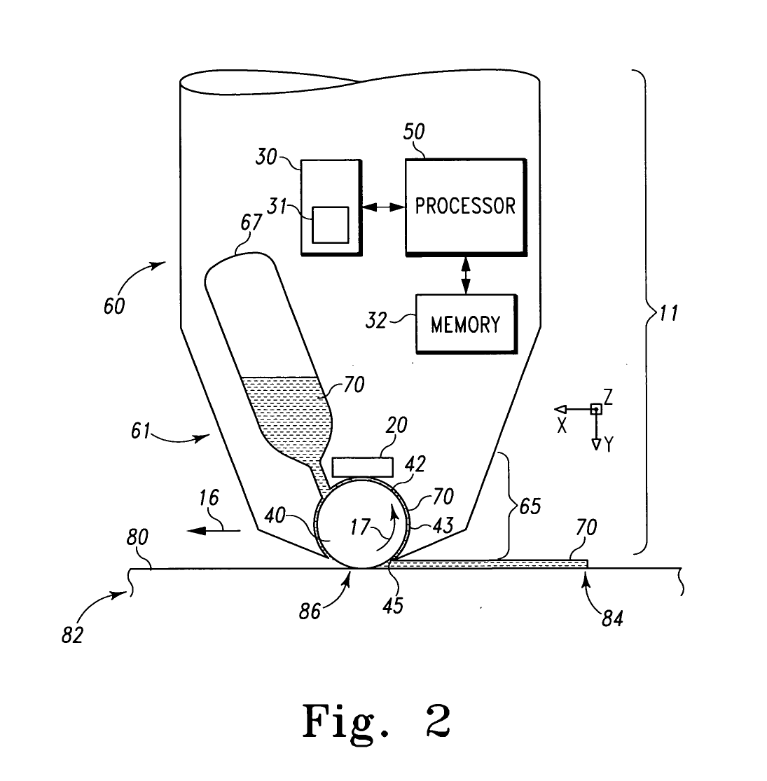

FIG. 2 is a diagram showing another embodiment of an apparatus 11 for generating navigation information. Apparatus 11 includes the components of apparatus 10, as described above with reference to FIG. 1, as well as an ink container 67 housed within the stylus 60. The ink container 67 is coupled to the ball 40 to supply ink 70 to the surface 42 of the ball 40. The ink container 67 holds ink 70 that flows from the ink container 67 to coat the surface 42 of the ball 40 with ink 70. The surface 42 of the ball 40 is textured to enable the ball 40 hold the ink 70 and to enable the writing surface 80 to rotate the ball 40. A portion of the ink 70 on the ink-coated ball 40 is transferred to the portion of the writing surface 80 that contacts the ink-coated ball 40. The ink 70 is shown in FIG. 2 with hatching in order to clearly indicate the location of the ink 70 in the apparatus 11 and on the writing surface 80. As shown in FIG. 2, the stylus tip 65 transfers ink 70 to writing surface 80 as a visual indication of the locus of contact between the ball 40 and the writing surface 80.

As shown in FIG. 2, a straight line of ink 70 is drawn when the user of the stylus 60 places the stylus tip 65 in contact with the writing surface 80 at the point indicated by reference number 84 and, while maintaining contact between the ink-coated ball 40 and the writing surface 80, moves the stylus tip 65 to the point indicated by reference number 86. During this exemplary movement of the stylus tip 65, the line of ink 70 is transferred to the writing surface 80, the rotation of the ball 40 is sensed by the sensor system 20, and the processor 50 determines changes in the orientation of the ball 40. The processor 50 executes software 31 to determine the distance between the point 84 and the point 86 and to determine the direction of the line of ink 70 between the point 84 and point 86.

For the example shown in FIG. 2, the processor 50 determines that the direction of the line of ink 70 between the point 86 and point 84 runs in the X-direction shown in FIG. 2. Based on successive sensings of the orientation-indicating property by the sensor system 20, the processor 50 also determines any changes in the direction of translational movement of the stylus tip 65 relative to the writing surface 80 that are made after the first point of contact during a writing event. As defined herein, a writing event begins when the processor 50 is powered ON and the ball 40 rotates for the first time. In yet another implementation of this embodiment, the apparatus 11 includes a power ON/OFF switch, to respectively initiate/terminate the operation of the processor 50.

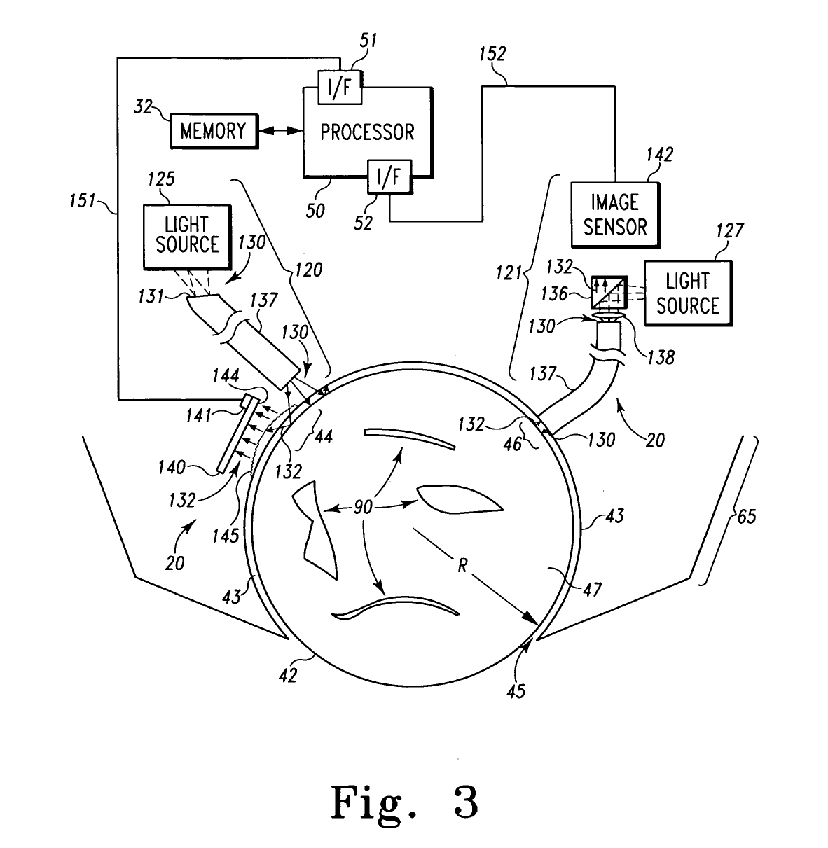

FIG. 3 is a diagram showing one embodiment of a ball 47 and a sensor system 20. The ball 47 is an embodiment of the ball 40 shown in FIG. 1. The ball 47 and the sensor system 20 are located in the apparatus 10 as described above with reference to FIG. 1. As shown in FIG. 3, the orientation-indicating property of the ball 47 is an optically-recognizable pattern indicated by reference number 90. The optically-recognizable pattern 90 is on the surface 42 of the ball 47. In one implementation of this embodiment, the optically-recognizable pattern 90 includes grooves of varying depth and shape in the surface 42 of the ball 47. In this case, the grooves are sensed by the sensor system 20. In another implementation of this embodiment, the optically-recognizable pattern 90 is a pattern of one material having a first color on the surface 42. The surface 41 of ball 47 is another material having a second color. In this case, the pattern of the color difference is sensed by the sensor system 20.

In this implementation of the apparatus 10, the sensor system 20 includes two optical pickup devices 120 and 121. The optical pickup devices 120 and 121 sense the optically-recognizable pattern 90 within the illuminated portions 44 and 46 of the surface 42 of the ball 47, respectively. The processor 50 recognizes the optically-recognizable pattern 90 in a sequence of images generated while the ball 47 is rotating in the cavity 45 due to a translational movement of the stylus tip 65 relative to the writing surface 80 (FIG. 1).

The optical pickup device 120 includes a light source 125 emitting light 130 that is coupled into an optical fiber 137. A portion of the emitted light 130 propagates through the optical fiber 137 and is incident on the ball 47. At least one image sensor 140 senses a portion of the light 132 reflected from the ball 47. The reflected light 132 provides an image of an illuminated portion 44 of the optically-recognizable pattern 90 that is illuminated by the light 130. As the ball 47 rotates, the optically-recognizable pattern 90 in the illuminated portion 44 changes and the image sensed by the image sensor 140 likewise changes. In this manner, the image sensor 140 senses sequential images of the illuminated portion 44 of the surface 42 of the ball 47 as the ball 47 rotates in the cavity 45. The information indicative of the images sequentially sensed by image sensor 140 is transmitted to the processor 50 via an image sensor interface 141, communication link 151 and a processor interface (I/F) 51. The communication link 151 is a wired communication link (for example, an optical fiber or copper wire communication link).

As shown in FIG. 3, the optical pickup device 120 includes a lens 145 that focuses reflected light 132 on the image sensor 140. The lens 145 shown in FIG. 3 is a diffractive optical element formed on the surface 43 of the cavity 45. In one implementation of this embodiment, the lens 145 is embodied as lens array positioned between the cavity surface 43 and the image sensor 140.

In one implementation of this embodiment, optical pickup device 120 includes a lens (not shown) that directs the emitted light onto the ball 47. In an example, a lens (not shown) is positioned between the light source 125 and the input end 131 of the optical fiber 137 to couple the light 130 into the optical fiber 137.

In another implementation of this embodiment, the optical pickup device 120 includes a first lens (not shown) that directs the emitted light 130 onto the ball 47 and a second lens, such as lens 145, that focuses reflected light 132 on the image sensor 140. In yet another implementation of this embodiment, one or more optical waveguides are implemented in place of the optical fiber 137.

Optical pickup device 121 is an alternative embodiment of the optical pickup device 120. The optical pickup device 120 is shown with optical pickup device 121 in FIG. 3 for convenience. In one implementation of this embodiment, the sensor system 20 located in the apparatus 10 (FIG. 1) includes more then one optical pickup device and they are all like optical pickup device 120. In another implementation of this embodiment, the sensor system 20 located in the apparatus 10 (FIG. 1) includes more than one optical pickup device and they are all like optical pickup device 121. In yet another implementation of this embodiment, the sensor system 20 located in the apparatus 10 (FIG. 1) includes more than one optical pickup device that each couple light from a single light source. Other implementations of the optical pick up device are possible. The processor 50 determines the orientation of the ball 47 from images sensed by the optical pickup devices constituting sensor system 20.

Optical pickup device 121 includes light source 127 emitting light 130 that is coupled into an optical fiber 137 through a beam splitter 136 and a lens 138. A portion of the emitted light 130 propagates through the optical fiber 137 and is incident on the ball 47. A portion of the light 130 that is incident on the ball 47 is reflected as light 132. Reflected light 132 is coupled back into the optical fiber 137. Reflected light 132 is output from the optical fiber 137 and passes through the lens 138 and the beam splitter 136 and is incident on image sensor 142. In this implementation, the optical pickup device 121 includes a lens 138 that focuses the emitted light 130 onto the end of the optical fiber 137 and focuses the reflected light 132 onto the image sensor 142.

In this manner, the image sensor 142 senses an image of the illuminated portion 46 of the surface 42 of the ball 47. The sensed image provides information indicative of the illuminated portion 46 of optically-recognizable pattern 90. The image sensor 142 is coupled to the processor 50 via communication link 152 and a processor interface (I/F) 52. The communication link 152 is a wired communication link.

In one implementation of this embodiment, the ball 47 and the sensor system 20 are located in the apparatus 11 as described above with reference to FIG. 2. In that case, the ink 70 is optically transparent at the wavelength of the light 130 and 132.

In another implementation of this embodiment, the image sensors 140 and/or 142 include sensor elements such as complementary metal-oxide-semiconductor (CMOS) sensor elements or charge-coupled device (CCD) sensor elements. Other suitable types of sensor elements generate electrical signals in response to incident light and can be used.

There are many possible orientations of the ball 47 within the cavity 45. During a translational movement of the stylus tip 65 relative to a surface 80 contacted by the ball 47, the ball 47 rotates from a first orientation to one of many possible second orientations. The second orientation depends on the direction of the movement of the stylus tip 65.

For every incremental change in the orientation of the ball 47, the direction and magnitude of the change in the orientation of the ball 47 are determined by the processor 50. The processor 50 receives information indicative of a first image of the illuminated portions 44 and/or 46 of the surface 42 of the ball 47 at a first time. At a second time, the processor 50 receives information indicative of a second image of the illuminated portions 44 and/or 46 of the surface 42 of the ball 47. The processor 50 determines how far and in what direction of the second image is shifted from the first image. For example, the processor 50 shifts the first image by one pixel in all directions and determines which of the shifted images most closely matches the received second image. Details of a method for tracking relative movement in this manner are described Blalock et al. in U.S. Pat. No. 5,729,008 incorporated herein by reference.

The processor 50 receives image data representing first images captured after a first incremental change in the orientation of the ball 47 from sensor system 20. Relational algorithms in the software 31 executed by the processor 50 determine a first direction and first magnitude of the change in the orientation of the ball 47 and the processor 50 stores the determined first direction and first magnitude in memory 32 in a sequential memory location or with a time stamp or sequence number. The processor 50 receives image data representing second images captured after a second incremental change in the orientation of the ball 47 from sensor system 20. The software 31 executed by the processor 50 determines a second direction and second magnitude of the change in the orientation of the ball 47 and the processor 50 stores the determined second direction and second magnitude in memory 32 in a sequential memory location or with a time stamp or sequence number, and so forth. The sensor system 20 continues to capture images, and the software 31 executed by the processor 50 continues to determine the direction and the magnitude of the incremental change in the orientation and to store the directions and magnitudes in memory 32 in a sequential memory location or with a time stamp or sequence number until the movement of the stylus 60 stops. To avoid ambiguities in the calculations, the timing between the capture of successive images must be less than the time required to rotate the ball 47 by 180°.

The software 31 executed by the processor 50 then links the sequential directions and magnitudes of the changes in the orientation of ball 47 to obtain sequential loci of points that are translatable to a movement executed by the stylus tip 65 relative to the surface 80 (FIG. 1). The relational algorithms in software 31 convert the arcs connecting the sequential loci of points to generate a replica of the movement of the stylus tip 65 relative to a surface 80 contacted by the ball 47. The ball 47 has a radius R which is stored in memory 32 and which is used in the relational algorithms to determine the length S of the incremental arc that equals the radius R times the angle of an incremental change in the orientation. The length S of the incremental arc equals the length of the incremental movement of stylus tip 65 relative to the surface 80. Thus, the incremental arcs connecting the sequential loci of points duplicate the length and the curvature of the complete movement traced or written on the surface 80 by the stylus tip 65. The accuracy of the tracking of the stylus tip 65 increases as time increments between the capture of successive images decreases.

In this manner, the software 31 determines the direction and magnitude of the change in the orientation of the ball 47 based on the changes in the appearance of optically-recognizable pattern 90 between sequentially captured images and derives the navigation information from the orientation changes.

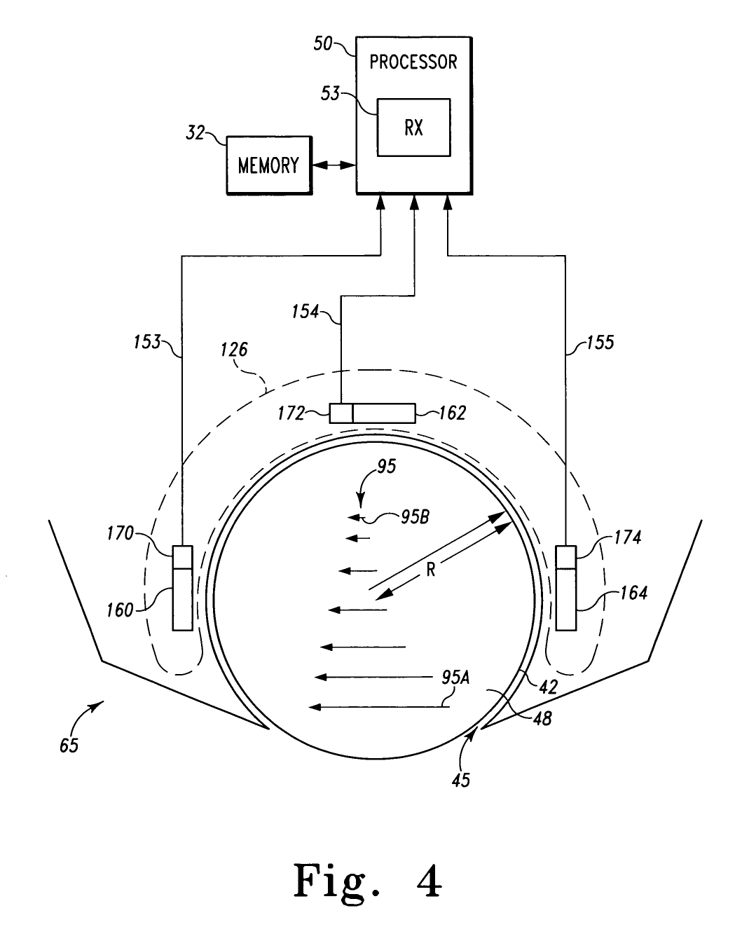

FIG. 4 is a diagram showing another embodiment of a ball 48 and the sensor system 20. The ball 48 is an embodiment of the ball 40 shown in FIG. 1. The ball 48 and the sensor system 20 are located in the apparatus 10 as described above with reference to FIG. 1. The ball 48 exhibits a magnetization pattern represented by the reference numeral 95 that provides the orientation-indicating property. The sensor system 20 comprises a magnetic pickup device 126 to sense a local magnetic field resulting from the magnetization pattern 95 of the ball. The sensed local magnetic field is dependent on the orientation of the ball 48. The processor 50 determines the magnitude and the direction of the changes in the orientation of the ball 48 in response to successive sensings of the local magnetic field.

In the implementation shown in FIG. 4, the magnetization pattern 95 is asymmetric with respect to rotation of the ball 48. In this exemplary asymmetric magnetization pattern 95, magnetization is represented by vectors of differing length ranging from a longest vector 95A at one end of the asymmetric magnetization pattern 95 to a shortest vector 95B at the other end of the asymmetric magnetization pattern 95. The length of each vector in the asymmetric magnetization pattern 95 is indicative of a respective magnetization in that region of the ball 48. The asymmetric pattern 95 allows the orientation of the ball 48 to be determined absolutely. Alternatively, the magnetization pattern is symmetric. In this case, only changes in the orientation are detected and not absolute orientation.

In one implementation of this embodiment, the asymmetric magnetization pattern is generated when a ferromagnetic ball 48 is placed in a non-uniform magnetic field that is strong enough to orient the magnetic domains in the ferromagnetic material. The exemplary asymmetric magnetization pattern 95 is imposed on the ball 48 by placing the ball 48 in a non-uniform magnetic field that differs in intensity across the ball 48 in a manner comparable to the ratio of vectors 95A/95B. When a ferromagnetic ball 48 is exposed to the non-uniform magnetic field, a larger percentage of the magnetic domains in the region of the vector 95A are oriented in regions where the magnetic field intensity is high and a smaller percentage of the magnetic domains in the region of the vector 95B are oriented in regions in which the magnetic field intensity is low. In one implementation of this embodiment, the whole ball 48 is formed from a magnetized ferromagnetic material. In another implementation of this embodiment, only a portion of the ball 48 is of a ferromagnetic material and the rest of the ball 48 is plastic. In yet another implementation, the ball 48 includes a magnetized element such as a small bar magnet located off-center in a plastic ball.

As shown in FIG. 4, the sensor system 20 includes a magnetic pickup device 126. The magnetic pickup device 126 includes at least two magnetic field detectors disposed circumferentially around the ball 48. In the example shown in FIG. 4, the magnetic pickup device 126 includes three magnetic field detectors 160, 162 and 164 each of which senses a different local magnetic field that depends on the orientation of the ball 48 due to the asymmetry of the magnetization pattern 95. With the ball 48 oriented as shown, the difference in the local magnetic field is most pronounced between the orthogonally located magnetic field detectors 160, 162 and 164.

The magnetic field detector 162 is oriented orthogonally to the magnetic field detectors 160 and 164. In one implementation of this embodiment, the magnetic field detectors 160, 162 or 164 are mutually orthogonal. In another implementation of this embodiment, magnetic pickup device 126 includes more than three magnetic field detectors of which of which three are mutually orthogonal. In yet another implementation of this embodiment, magnetic pickup device 126 includes two or more pairs of magnetic field detectors in which the magnetic field detectors in each pair are orthogonal to each other. Each magnetic field detector 160, 162 and 164 includes a coil, a thin film coil, a magnetoresistive device, a Hall effect device, a giant magnetoresitive device, a flux gate or combinations thereof.

The transmitters 170, 172 and 174 transmit information indicative of the local magnetic field over a wired communication link. The magnetic field detectors 160, 162 and 164 are each coupled to a respective transmitter 170, 172 and 174. The transmitter 170 transmits information indicative of the local magnetic field at magnetic field detector 160 over the wired communication link 153 to the receiver (RX) 53 in the processor 50. The transmitter 172 transmits information indicative of the local magnetic field at magnetic field detector 162 over the wired communication link 154 to the receiver 53 in the processor 50. The transmitter 174 transmits information indicative of the local magnetic field at magnetic field detector 164 over the wired communication link 155 to the receiver 53 in the processor 50.

In another implementation of this embodiment, the magnetic field detectors 160, 162 and 164 are each coupled to a single transmitter that transmits information indicative of the local magnetic field at the magnetic field detectors 160, 162 and 164 over a wired communication link. In yet another implementation of such an embodiment, the single transmitter transmits information indicative of the local magnetic fields at the magnetic field detectors 160, 162 and 164 over a wired communication link using a time division multiplexing protocol.

The magnetic pickup device 126 senses the local magnetic field that is dependent on the orientation of the ball 48 and that results from the magnetization pattern 95 of the ball 48. The processor 50 determines the magnitude and the direction of the changes in the orientation of the ball 48 in response to successive sensings of the local magnetic field.

There are many possible orientations of the ball 48 within the cavity 45. During a translational movement of the stylus tip 65 relative to a surface 80 contacted by the ball 48, the ball 48 rotates from a first orientation to one of many possible second orientations. The second orientation depends on the direction of the movement of the stylus tip 65.

For every incremental change in the orientation of the ball 48, the direction and magnitude of the change in the orientation of the ball 48 are determined by the processor 50. The processor 50 receives information indicative of a first local magnetic field at a first time from sensor system 20. At a second time, the processor 50 receives information indicative of a second local magnetic field from the sensor system 20.

The processor 50 receives from sensor system 20 local magnetic field data representing the sensed first local magnetic field after a first incremental change in the orientation of the ball 48, relational algorithms in the software 31 executed by the processor 50 determine a first direction and first magnitude of the change in the orientation of the ball 48 and the processor 50 stores the determined first direction and first magnitude in memory 32 in a sequential memory location or with a time stamp or sequence number. The processor 50 receives from sensor system 20 local magnetic field data representing second sensed local magnetic field after a second incremental change in the orientation of the ball 48, the software 31 executed by the processor 50 determines a second direction and second magnitude of the change in the orientation of the ball 48 and the processor 50 stores the determined second direction and second magnitude in memory 32 in a sequential memory location or with a time stamp or sequence number, and so forth. The sensor system 20 continues to sense the local magnetic fields at the magnetic field detectors 160, 162 and 164, and the software 31 executed by the processor 50 continues to determine the direction and the magnitude of each incremental change in the orientation and to store the directions and magnitudes in memory 32 in a sequential memory location or with a time stamp or sequence number until the movement of the stylus 60 stops. To avoid ambiguities in the calculations, the timing between the capture of successive sensings must be less than the time required to rotate the ball 48 by 180°.

The software 31 executed by the processor 50 then links the sequential directions and magnitudes of the changes in the orientation of ball 48 to obtain sequential loci of points that are translatable to a movement executed by the stylus tip 65 relative to the surface 80 (FIG. 1). The relational algorithms in software 31 operate as described above with reference to FIG. 3 to convert the arcs connecting the sequential loci of points to generate a replica of the translational movement of the stylus tip 65 relative to a surface 80 contacted by the ball 48.

In this manner, the software 31 determines the direction and magnitude of the change in the orientation of the ball 48 based on the changes in the local magnetic field at the magnetic pickup device 126 between sequential local magnetic field sensings and derives the navigation information from the orientation changes.

In one implementation of this embodiment, the apparatus 10 implements a table stored in the memory 32 to correlate the magnetic fields local to the magnetic field detectors 160, 162, and 164 of the magnetic pickup device 126 to the orientation of the ball 48. In another implementation of this embodiment, the ball 48 and magnetic pickup device 126 are implemented in the apparatus 11 described above with reference to FIG. 2. In this case, the ink 70 does not need to be optically transparent.

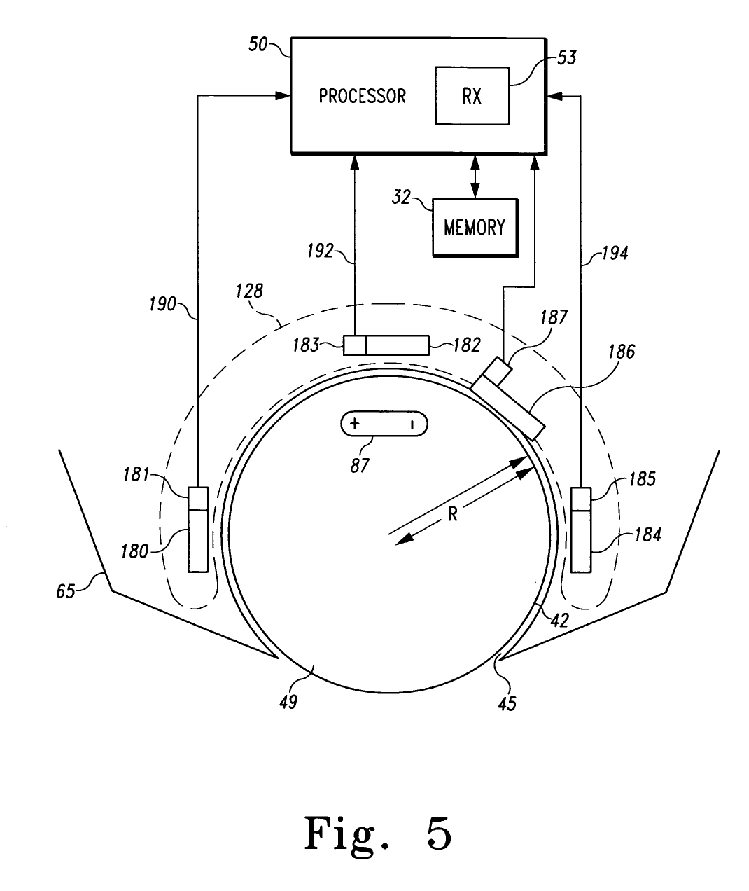

FIG. 5 is a diagram showing yet another embodiment of a ball 49 and a sensor system 20. The ball 49 is an embodiment of the ball 40 shown in FIG. 1. The ball 49 and the sensor system 20 are located in the apparatus 10 as described above with reference to FIG. 1. In this embodiment, the distinguishable property of the ball 49 is an electrostatic field generated by an electret 87 embedded of center in the ball 49. An electret is a dielectric material with a long-lasting electrostatic polarization. Electrets are produced by heating appropriate dielectric materials to a high temperature and then letting the material cool while held in an electric field. The electret 87 is located off center in the ball 49 so the electrostatic field exhibited by the ball 49 is asymmetric with respect to rotation of the ball 49 and the absolute orientation of the ball 49 can be determined. Alternatively, the electret 87 is centered in the ball 49. In this case, only changes in the orientation of the ball 49 are detected and not the absolute orientation.

In one implementation of this embodiment, the whole ball 49 is an electret. In another implementation of this embodiment, only a portion of the ball 49 is an electret and the rest of the ball 49 is plastic.

As shown in FIG. 5, the sensor system 20 includes an electrostatic pickup device 128 and a pressure sensor 186. The electrostatic pickup device 128 includes at least two electric field detectors disposed circumferentially around the ball 49. In the example shown in FIG. 5, the electrostatic pickup device 128 includes three electric field detectors 180, 182 and 184 each of which senses the electric field local to the electric field detector. Due to the offset of the electret 87 from the center of the ball 49, each of the electric field detectors 180, 182 and 184 experiences a different local electric field that depends on the orientation of the ball 49. With the ball 49 oriented as shown, the difference in the local electric field is most pronounced between the orthogonally-located electric field detectors 180, 182 and 184.

The electric field detector 182 is oriented orthogonally to the electric field detectors 180 and 184. In one implementation of this embodiment, the electric field detectors 180, 182 or 184 are mutually orthogonal. In another implementation of this embodiment, electrostatic pickup device 128 includes more than three electric field detectors of which of which three are mutually orthogonal. In yet another implementation of this embodiment, electrostatic pickup device 128 includes two or more pairs of electric field detectors in which the electric field detectors in each pair are orthogonal to each other.

The transmitters 181, 183 and 185 transmit information indicative of the local electric field over a wired communication link. The electric field detectors 180, 182 and 184 are each coupled to a respective transmitter 181, 183 and 185. The transmitter 181 transmits information indicative of the local electric field at electric field detector 180 over the wired communication link 190 to the receiver 53 in the processor 50. The transmitter 183 transmits information indicative of the local electric field at electric field detector 182 over the wired communication link 192 to the receiver 53 in the processor 50. The transmitter 185 transmits information indicative of the local electric field at electric field detector 184 over the wired communication link 194 to the receiver 53 in the processor 50.

In another implementation of this embodiment, the electric field detectors 180, 182 and 184 are each coupled to a single transmitter that transmits information indicative of the local electric field at all of the electric field detectors 180, 182 and 184 over a wired communication link. In yet another implementation of such an embodiment, the single transmitter transmits information indicative of the local electric fields at the electric field detectors 180, 182 and 184 over a wired communication link using a time division multiplexing protocol.

The pressure sensor 186 is located in contact with the circumference of the ball 49 and is coupled to the transmitter 187. In one implementation of this embodiment, the pressure sensor 186 provides information indicative of a click event to the processor 50 via the transmitter 186. A click event occurs when a user of the stylus 60 pushes down on the ball 49 and a transient spike in pressure is sensed at the pressure sensor 186. In an exemplary case, the user controls a cursor on a display with the stylus 60 and selects a file displayed as an icon on the display by placing the cursor over the icon and pushing down on the ball 49 to generate a pressure pulse on the pressure sensor 186. The transmitter 187 transmits information indicative of a click event to processor 50 over a wired communication link.

In one implementation of this embodiment, the pressure sensor 186 is not included in the stylus tip 65 of FIG. 5. In another implementation of this embodiment, there are two or more pressure sensors 186 disposed in contact with different locations on the arc of the ball 49 and all the pressure sensors are coupled to a single transmitter. In other implementations of the apparatus 10 or 11 (FIG. 1 or 2, respectively), there are two or more pressure sensors 186 disposed circumferentially around the ball 49 and each pressure sensor is coupled to a transmitter to transmit information indicative of a click event to the processor 50.

The electrostatic pickup device 128 senses the local electrostatic field that is dependent on the orientation of the ball 49 and that results from the electrostatic field exhibited by the ball 49. The processor 50 determines the magnitude and the direction of the changes in the orientation of the ball 49 in response to successive sensings of the local electrostatic field.

There are many possible orientations of the ball 49 within the cavity 45. During a translational movement of the stylus tip 65 relative to the surface 80 contacted by the ball 49, the ball 49 rotates from a first orientation to one of many possible second orientations. The second orientation depends on the direction of the movement of the stylus tip 65.

For every incremental change in the orientation of the ball 49, the direction and magnitude of the change in the orientation of the ball 49 are determined by the processor 50. The processor 50 receives information indicative of a first local electrostatic field at a first time from sensor system 20. At a second time, the processor 50 receives information indicative of a second local electrostatic field from the sensor system 20.

The processor 50 receives local electrostatic field data representing the sensed first local electrostatic field from sensor system 20 after a first incremental change in the orientation of the ball 49, relational algorithms in the software 31 executed by the processor 50 determine a first direction and first magnitude of the change in the orientation of the ball 49 and the processor 50 stores the determined first direction and first magnitude in memory 32 in a sequential memory location or with a time stamp or sequence number. The processor 50 receives local electrostatic field data representing second sensed local electrostatic fields from sensor system 20 after a second incremental change in the orientation of the ball 49, the software 31 executed by the processor 50 determines a second direction and second magnitude of the change in the orientation of the ball 49 and the processor 50 stores the determined second direction and second magnitude in memory 32 in a sequential memory location or with a time stamp or sequence number, and so forth. The sensor system 20 continues to sense the local electrostatic fields at the electric field detectors 180, 182 and 184, and the software 31 executed by the processor 50 continues to determine the direction and the magnitude of the incremental change in the orientation and to store the directions and magnitudes in memory 32 in a sequential memory location or with a time stamp or sequence number until the movement of the stylus 60 stops. To avoid ambiguities in the calculations, the timing between the capture of successive sensings must be less than the time required to rotate the ball 49 by 180°.

The software 31 executed by the processor 50 then links the sequential directions and magnitudes of the changes in the orientation of ball 49 to obtain sequential loci of points that are translatable to a movement executed by the stylus tip 65 relative to the surface 80 (FIG. 1). The relational algorithms in software 31 operate as described above with reference to FIG. 3 to convert the arcs connecting the sequential loci of points to generate a replica of the translational movement of the stylus tip 65 relative to a surface 80 contacted by the ball 49.

In this manner, the software 31 determines the direction and magnitude of the change in the orientation of the ball 49 based on the changes in the local electrostatic field at the electrostatic pickup device 128 between sequential local electrostatic field sensings and derives the navigation information from the orientation changes.

In one implementation of this embodiment, the apparatus 10 implements a table stored in the memory 32 to correlate the electrostatic fields local to the electrostatic field detectors 180, 182, and 184 of the electrostatic pickup device 128 to the orientation of the ball 49. In another implementation of this embodiment, the ball 49 and electrostatic pickup device 128 are implemented in the apparatus 11 described above with reference to FIG. 2. In this case, the ink 70 does not need to be optically transparent.

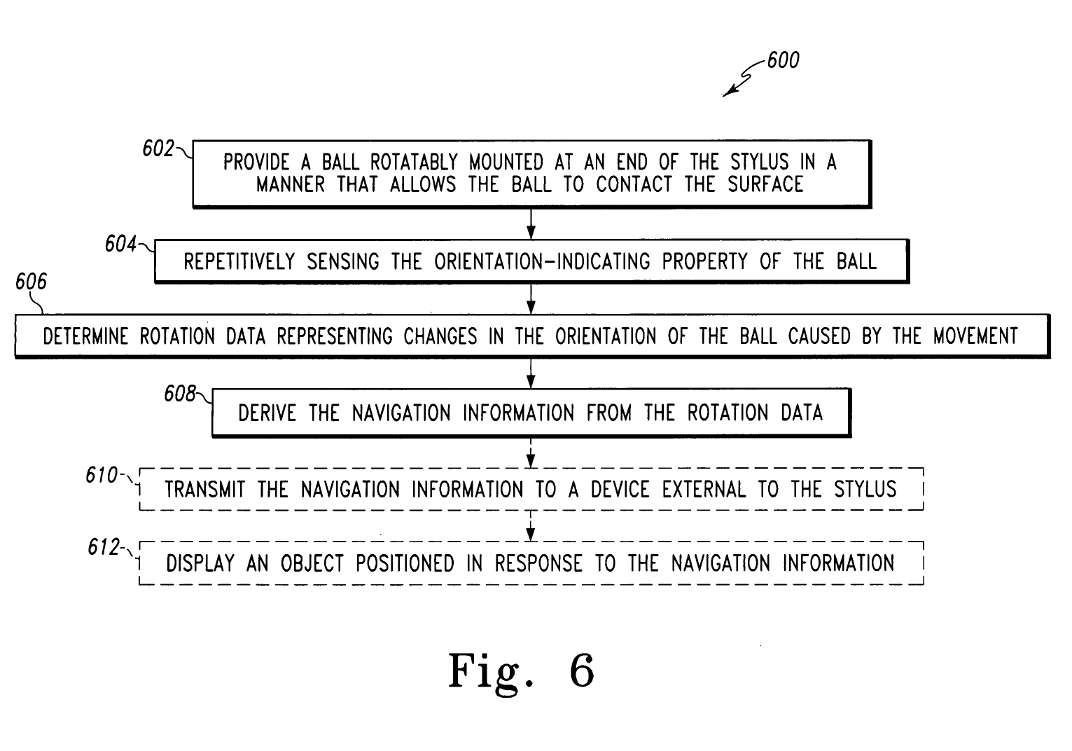

FIG. 6 is a flowchart of an embodiment of a method 600 to obtain navigation information from a ball 40.

At block 602, a ball 40 is provided rotatably mounted at the end 61 of a stylus 60 in a manner that allows the ball 40 to contact the surface 80. At block 604, the orientation-indicating property of the ball 40 is repetitively sensed. In various implementations, the sensing comprises sensing the orientation-indicating property optically, sensing the orientation-indicating property magnetically, or sensing the orientation-indicating property electrostatically.

At block 606, rotation data is determined in response to the sensing of the orientation-indicating property of the ball 40. The rotation data represents changes in the orientation of the ball 40 caused by a translational movement of a stylus relative to a surface. In one implementation of this embodiment, the rotation data represents a magnitude and a direction of the change in the orientation. At block 608, navigation information is derived from the rotation data.

Blocks 610 and 612 are optional. At block 610, navigation information is transmitted to a device external to the stylus 60. At block 612, an object that is positioned in response to the navigation information is displayed. Some implementations of method 600, are implemented using the stylus tip 65 described above with reference to FIGS. 1-5, but method 600 is not limited to these embodiments.

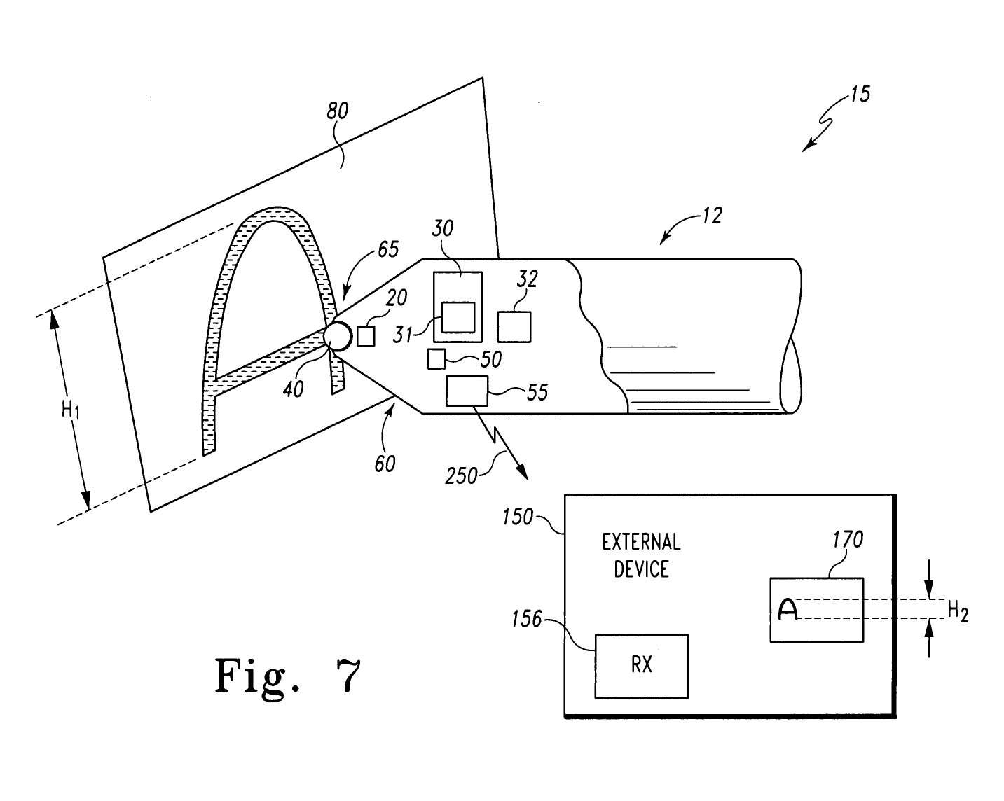

In one implementation of this embodiment, the stylus is used to control a cursor on a display and the position at which the cursor is displayed is determined in response to the navigation information. In another implementation of this embodiment, the stylus 60 is a pen and a scaled reproduction of a stroke executed by the stylus tip 65 relative to the surface 80 (FIG. 1) is displayed in response to the navigation information as shown in FIG. 7.

FIG. 7 is a diagram showing a system 15 that displays an object positioned in response to the navigation information generated by the processor 50. The apparatus 12 includes the components of apparatus 11 (FIG. 2) and additionally includes a wireless transmitter 55 that transmits a wireless signal 250 to a receiver 156 in the external device 150. The external device 150 includes a display 170.

The exemplary object displayed in FIG. 7 is the letter “A” that is written on the writing surface 80 by a user of the apparatus 12. The navigation information is derived by the processor 50 in response to the changes in orientation of the ball 40 of the stylus tip 65 while the letter “A” is written. In this exemplary case, the external device 150 processes the received wireless signal in order to display a scaled reproduction of the letter “A” that is written on the writing surface 80.

As shown in this example, the translational movements of the stylus tip 65 relative to the writing surface 80 detected by changes in the orientation of ball 40 result in the formation of a letter “A” having a height H₁ on the writing surface 80. The navigation information derived by the processor 50 in response to the changes in orientation of the ball 40 is transmitted to the receiver 156. The received signal is processed at the external device 150 and a scaled reproduction of the letter “A” having a height H₂ is displayed on the display 70.

In one implementation of this embodiment, the ratio of height H₁ to height H₂ is fixed. In another implementation of this embodiment, the ratio of height H₁ to height H₂ is variable and determined by the external device 150 to fit the stylus-tip movement into an assigned region of the display 170. In yet another implementation of this embodiment, the ratio of height H₁ to height H₂ is variable and selected by a user of the apparatus 12. In this case, the apparatus 12 includes an input mechanism (not shown) for the user to select the ratio.

In yet another implementation of this embodiment, the stylus 12 does not include the processor 50 or the memory 32. In this case, the external device 150 includes a processor that performs the functions described for the processor 50. The wireless transmitter 55 in the stylus 60 sends the orientation information indicative of the repetitively sensed orientation-indicating property of the ball 40 to the processor in the external device 150 and the processor in the external device 150 determines the rotation data in response to the orientation information and derives the navigation information from the rotation data.

In yet another implementation of this embodiment, the apparatuses 10, 11 and 12 include a power ON/OFF switch, to respectively initiate/terminate the operation of the processor 50. In yet another implementation of this embodiment, the apparatus 12 includes a transmit ON/OFF switch, to respectively initiate/terminate the transmission of the stylus-tip movements to the external device 150. All of the apparatuses 10, 11 and 12 can include a pressure sensor similar to sensor 186 shown in FIG. 5.

In one implementation of this embodiment, the stylus 60 is used as a computer peripheral, such as a mouse. In this case, the navigation information transmitted to a processor external to the stylus 60 of system 15 is used to position a cursor on the display of a computer screen.

Although specific embodiments have been illustrated and described herein, it will be appreciated that any arrangement that is calculated to achieve the same purpose may be substituted for the specific embodiment shown. This application is intended to cover any adaptions or variations of the present invention. Therefore, it is manifestly intended that this invention be limited only by the claims and the equivalents thereof.

We claim:

1. An apparatus for generating navigation information indicative of translational movement of a stylus, the apparatus comprising:
a ball rotatably mounted at an end of the stylus, the ball having an orientation-indicating property;
a sensor system arranged to sense the orientation-indicating property of the ball; and
coupled to the sensor system, a processor operable in response to successive sensings of the orientation-indicating property to determine changes in the orientation of the ball and to derive the navigation information from the orientation changes.

2. The apparatus of claim 1, in which:
the apparatus additionally comprises a stylus tip at the end of the stylus;
the ball is rotatably mounted in the stylus tip and the sensor system is located within the stylus tip; and
the ball rotates in proportion to translational movement of the stylus tip relative to a surface contacted by the ball.

3. The apparatus of claim 2, further comprising an ink container housed within the stylus, the ink container coupled to the ball to supply ink to the surface thereof.

4. The apparatus of claim 1, in which:
the ball exhibits an optically-recognizable pattern on its surface, the pattern providing the orientation-indicating property;
the sensor system comprises an optical pickup device operable to sense an image of the optically-recognizable pattern on the surface of the ball, the image depending on the orientation of the ball; and
the processor is operable to determine magnitude and direction of the changes in the orientation of the ball in response to successive sensings of the image.

5. The apparatus of claim 4, in which the optical pickup device comprises:
a light source arranged to illuminate the ball; and
an image sensor arranged to receive light reflected by the ball.

6. The apparatus of claim 5, in which the optical pickup device additionally comprises an optical element arranged to one of: focus light from the light source onto the ball; and focus the light reflected by the ball onto the image sensor.

7. The apparatus of claim 1, in which:
the ball exhibits a magnetization pattern, the magnetization pattern providing the orientation-indicating property;
the sensor system comprises a magnetic pickup device adapted to sense a local magnetic field resulting from the magnetization pattern of the ball, the local magnetic field dependent on the orientation of the ball; and
the processor is operable to determine magnitude and direction of the changes in the orientation of the ball in response to successive sensings of the local magnetic field.

8. The apparatus of claim 7, in which the magnetization pattern is asymmetric with respect to rotation of the ball.

9. The apparatus of claim 7, in which the ball comprises a magnetized element.

10. The apparatus of claim 7, in which the magnetic pickup device comprises magnetic field detectors disposed circumferentially around the ball.

11. The apparatus of claim 10, in which at least two of the magnetic field detectors are positioned to be sensitive to orthogonal magnetic field components.

12. The apparatus of claim 10, in which each magnetic field detector includes one of a coil, a thin film coil, a magnetoresistive device, a Hall effect device, a giant magnetoresitive device, a flux gate and a combination of at least two thereof.

13. The apparatus of claim 1, in which:
the ball exhibits an electrostatic field, the electrostatic field providing the orientation-indicating property;
the sensor system comprises an electrostatic pickup device operable to sense a local electrostatic field resulting from the electrostatic field exhibited by the ball, the local electrostatic field dependent on the orientation of the ball; and
the processor is operable to determine magnitude and direction of the changes in the orientation of the ball in response to successive sensings of the local electrostatic field.

14. The apparatus of claim 13, in which the electrostatic field exhibited by the ball is asymmetric with respect to rotation of the ball.

15. The apparatus of claim 1, additionally comprising a pressure sensor responsive to pressure applied to the ball.

16. A method for obtaining navigation information representing translational movement of a stylus relative to a surface, the method comprising:
providing a ball rotatably mounted at an end of the stylus in a manner that allows the ball to contact the surface, the ball having an orientation-indicating property;
repetitively sensing the orientation-indicating property of the ball;
in response to the sensing of the orientation-indicating property, determining rotation data representing changes in the orientation of the ball caused by the movement; and
deriving the navigation information from the rotation data.

17. The method of claim 16, additionally comprising transmitting the navigation information to a processor external to the stylus.

18. The method of claim 16, additionally comprising displaying an object positioned in response to the navigation information.

19. The method of claim 16, in which the sensing comprises one of: sensing the orientation-indicating property optically; sensing the orientation-indicating property magnetically; and sensing the orientation-indicating property electrostatically.

20. The method of claim 16, in which the rotation data comprises a magnitude and a direction of the change in the orientation.

21. A storage medium in which is stored a program operable to instruct a processor to perform operations that generate navigation information representing translational movement of a stylus relative to a surface, the operations comprising:
receiving sensing data indicative of a sensed orientation-indicating property of a ball rotatably mounted in a stylus tip at one end of a stylus;
in response to the sensing data, determining rotation data representing changes in orientation of the ball due to translational movement of the stylus tip relative to a surface; and
deriving navigation information from the rotation data, the navigation information representing the translational movement of the stylus tip.

22. The storage medium of claim 21, in which the program is additionally operable to cause the processor to transmit the navigation information to processor external of the stylus.

23. The storage medium of claim 21, in which the program is additionally operable to cause the processor to display an object positioned in response to the navigation information.
